(19) United States
(12) Patent Application Publication
(10) Pub. No.: US 2007/0115848 A1
(43) Pub. Date: May 24, 2007

(54) Adaptive application sensitive rate control system for packetized networks

(76) Inventors: Kevin Chean, Troy, NY (US); Michael Hartman, Clifton Park, NY (US); Scott Evans, Burnt Hills, NY (US); Richard Zinser, Niskayuna, NY (US)

Correspondence Address: DUANE MORRIS LLP, PO BOX 5203, PRINCETON, NJ, 08543-5203, US

(21) Appl. No.: 11/283,594

(22) Filed: Nov. 18, 2005

(51) Int. Cl. H04J 1/16

(52) U.S. Cl. 370/252; 370/235

(57) ABSTRACT

A method operates a limited-bandwidth network in a differential service (DiffServ) mode with DCCP congestion control to provide high throughput with good QoS.

### FIELD OF THE INVENTION

This invention relates to network communications, and more particularly to methods for controlling the rate or protection of applications communicating over the network in response to network characteristics.

### BACKGROUND OF THE INVENTION

During emergencies, wireless networks may be unable to handle a high volume of calls because of the limited bandwidth of the network. If an emergency responder needs to make an important call by way of the network and the network is congested, this important call may be delayed, or may even not go through. Worse yet, if the network is designed to handle a maximum number of calls, such as 20 calls, and a 21^{st} call comes in, that 21^{st} call will take resources from each of the other 20 calls. There is a possibility that under such conditions none of the calls will get through.

A current approach toward amelioration of this problem uses Multi-Level Precedence and Preemption (MLPP), which gives higher priority calls precedence of the network resources. This technique has the disadvantage that it preempts lower-priority calls.

Improved andor alternative network communication arrangements are desired.

### SUMMARY OF THE INVENTION

A method according to an aspect of the invention is for communicating among multiple nodes of a network. The network has limited bandwidth, and comprises at least plural nodes. The method comprises the step of providing a plurality of applications at least one of the nodes, where each of the applications has at least one of (a) transmission rate and (b) protection or error rate which differs from others of the applications at the corresponding node. The method provides network transport with a network transport protocol that reports network performance characteristics. These characteristics may be indications of network congestion, such as packet delay or nonarrival. The network performance characteristics are processed for selecting a particular one of the applications in such a manner to tend to maintain the QoS.

According to another aspect of the invention, a method for communication among multiple nodes of a bandwidth-limited network which comprises at least first and second nodes comprises the step of, at each of the first and second nodes, providing a plurality of applications. Each of the applications has at least one of (a) transmission rate and (b) protection which differs from others of the applications at the corresponding node. A network transport protocol is provided, which reports network performance characteristics such as congestion packet delay or nonarrival. One of the plurality of applications is selected in response to the network performance characteristics to tend to maintain a given QoS.

A method according to an other aspect of the invention is for communicating among multiple users by way of a network defining nodes and having a limited bandwidth. Each of the nodes is associated with a gateway, and each of the gateways is associated with a set of variable-bit-rate vocoders, which set may contain as few as one vocoder. The method comprises the step of, at any one of the vocoders of a set, transmitting information packets at a bit rate to an associated gateway together with information identifying the particular vocoder from which the packet transmission is made, and noting the time at which the packet was transmitted. At each gateway, the vocoder identification information is compared with prestored information relating the vocoder identification to packet priority, to thereby assign a user priority to each of the information packets. The gateway communicates the packet and its user priority over the network. When the packet reaches its destination, arrival confirmation information is transmitted back, over the network, to that one vocoder which originated the packet. The arrival confirmation information includes at least information relating to the time of arrival of the packet at its destination. At the one vocoder, the time of transmission of the packet is compared with at least one of (a) the time of arrival of the packet and (b) a lack of the arrival confirmation within a predetermined time, and the bit rate of a subsequent packet transmission is adjusted in response thereto. Ordinarily, when there is a long delay between the transmission of a packet and its arrival at its destination, the vocoder bit rate on subsequent packet transmissions is reduced. Similarly, if it is established that a packet has not arrived, as indicated by lack of an arrival confirmation, the vocoder bit rate is reduced on subsequent packet transmissions. A minimum bit rate may be applied.

In a particular mode of this other method, the step of transmitting arrival confirmation information includes the step of transmitting in a DDCP protocol, and in some modes, one of TCP and UDP protocols.

In a different version of this other method, the step of transmitting arrival confirmation information back to the originating vocoder includes the step of incorporating into the arrival confirmation information matter or information relating to the bit error rate of the arrived packet. In this mode, the step of adjusting the bit rate of a subsequent packet transmission is further responsive to the bit error rate.

In yet another mode of this other method, the step of transmitting information packets at a bit rate to an associated gateway includes the step of transmitting the information packets at the highest possible bit rate so long no indication of congestion is received.

### BRIEF DESCRIPTION OF THE DRAWING

FIG. 1 is a simplified block diagram of a network according to an aspect of the invention;

FIG. 2 is a simplified block diagram of a network similar to that of FIG. 1, in which particular interface congestion controller and network transport protocol with delay and loss reporting is used;

FIG. 3 is a histogram-like plot of bandwidth as a function of time in a network subject to variation in bandwidth.

### DETAILED DESCRIPTION OF THE INVENTION

A disadvantage of a priority preemption approach such as that of the prior art is that lower-priority calls are completely ejected from the network in the presence of congestion, and consequently never arrive at their destination. A method according to an aspect of the invention is for communicating among multiple users by way of a network defining terminals or nodes, having a limited bandwidth, and operating in a differential service mode. Each of the nodes uses a system of application source rate control based on network operational characteristics. One example which is tied to voice compression is called Multi-Level Congestion Control Variable Rate or Protection Application (MLCCV). In general, a variable rate andor protection application can process VoIP, Video, and Sensor data. Multi-Level Congestion Control is associated with an interface module that gathers network operational statistics, system policy information, and application requirements. One such example is a gateway. The exemplary protocol MLCCV primarily includes two parts, namely 1) a variable rate andor protection application in the application layer and 2) a new protocol in the transport layer combining the best properties of TCP and UDP for transmitting voice data. Some embodiments combine the features of variable rate applications, network protocols that include operational characteristics, interface elements and control approaches. The illustrative method comprises the step of, at any one of the terminals or nodes of a set of terminals, transmitting information packets at a bit rate to an associated gateway together with information identifying the particular node from which the packet transmission is made. At each gateway, the node identification information is compared with prestored information relating the node identification to packet priority, to thereby assign a user priority to each of the information packets. The gateway communicates the packet and its user priority over the network, by marking each of the packets. Network congestion information is transmitted back over the network, to that one node which originated the packet. The network congestion information can include (a) information relating to the time of arrival of the packet at its destination, (b) packet nonarrival, and/or (c) packet error information. Other information that describes the load of the network can also be transmitted back. At one of the nodes, (a) if the network congestion information includes time of arrival, the time of transmission of the packet is compared with the time of arrival, (b) if the network congestion information includes nonarrival information, the nonarrival information is evaluated, and (c) if the network congestion information includes bit error rate, the bit error rate is evaluated, to determine network congestion, and the bit rate of a subsequent packet transmission is adjusted in response thereto. Ordinarily, when congestion is present, the Variable Rate or Protection Application bit rate on subsequent packet transmissions is reduced.

An aspect of the invention defines a new communication system, the Multi-Level Congestion Control Variable Rate or Protection Application (MLCCV) for use with a network. The MMCCV communication system may be used for any type of data or information, but an important example includes voice communications, as for example voice packet communications. The MLCCV method provides for continued propagation of the lower-priority calls in the presence of network congestion, but at lower quality, without impacting the high-priority calls. The Variable Rate or Protection Application is an application which can controllably change its transmission bit rate andor its error protection scheme, which in turn affects the transmission bit rate. In this context, the term “variable” includes the concept of step-variable, which is to say that the application may include, or be viewed as including, multiple sub-applications or “pages,” each of which, or at least some of which, has/have a bit rate or error control scheme which differs from that of other sub-applications or pages. The “controllable” aspect refers to control of the bit rate andor protection by means of a control signal applied from without the Variable rate andor protection application. An example of a variable bit rate or protection application is a vocoder which is switchable among various encoding schemes to thereby vary the quality of service (QoS) and also the bit rate. The Variable rate andor protection application with which the multi-level congestion control is used may include VoIP, video, or sensor data. The MLCCV system provides the possibility of improved throughput with high quality of service (QoS) or calls. The Multi-Level Congestion Controlled Variable rate andor protection application (MLCCV) is a system that communicates signals to the variable rate andor protection application in the application layer which represent the bit rate at which the variable rate andor protection application should transmit, based on the congestion of the network and the priority of the user. The decisions are made at the node by notification from the network. The Multi-Level Congestion Controlled variable rate andor protection application protocol can be used with DIFFerentiated SERVices (DiffServ), which is a policy-based method for bandwidth allocation. More particularly, DiffServ is a method for adding Quality-of-Service (QoS) to Internet Protocol (IP). When MLCCV is combined with DiffServ, multi-level service for different priority user can be achieved. The use of MLCCV provides the network administrator with flexibility in (a) attempting to get as many calls or messages as possible into the band-limited network, and (b) completing as many high-priority messages as possible. Transmission Control Protocol (TCP) can also be used as a transmission protocol providing congestion reporting.

One may easily imagine a tradeoff between high network utilization with low quality calls and low network utilization with high quality calls. The use of MLCCV allows for a balance of high quality and lower quality calls based on priority of the user. Under some circumstances, MLCCV can also provide better bandwidth usage, because when a call which requires high quality is subject to substantial packet loss, drops or dropouts, MLCVV can change the transmissions to a lower bit rate instead of continuing to attempt transmission at high bit rates. An advantage is achieved in this situation, because continuing attempts at the high bit rate in the presence of packet drops can result in the calls becoming unintelligible at high packet loss. If replacement packets are sent to carry the information of dropped packets, the unnecessary packets tend to congest the network.

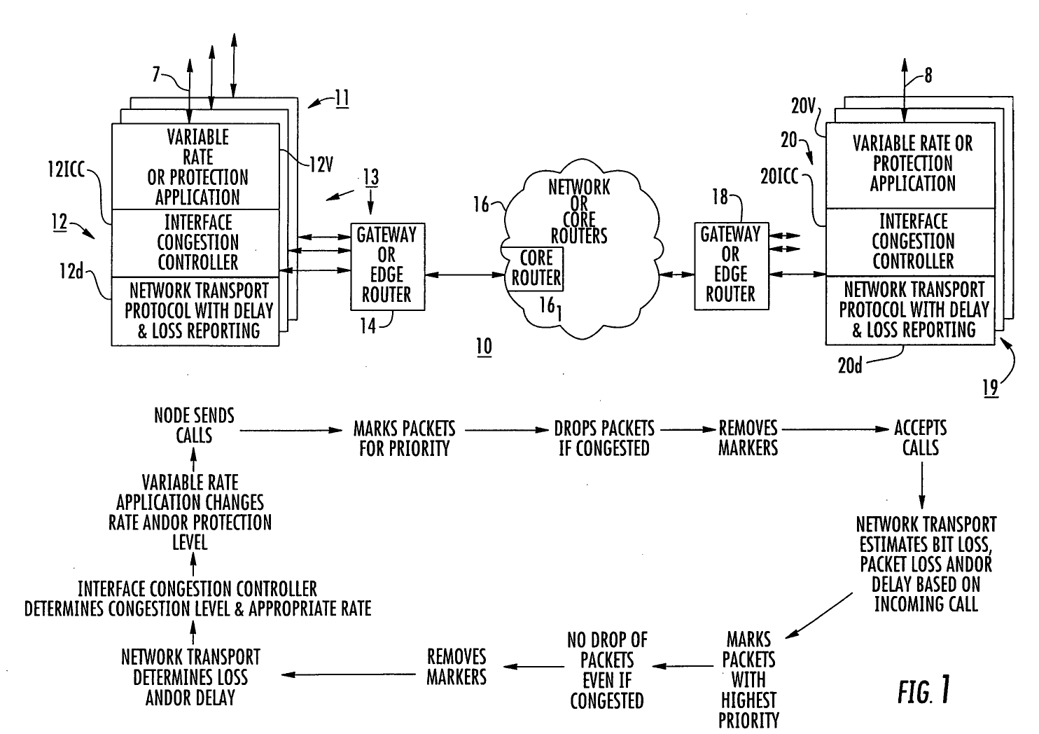

FIG. 1 is a simplified block diagram representing a network communication system 10. System 10 includes a terminal or node designated generally as 12 with an application-layer Variable (or switchable) Rate andor Protection application, illustrated as a block 12v, which is supported (in a computer protocol layer sense) by an Interface Congestion Controller illustrated as a block 12icc, which in turn is supported by a Network Transport Protocol with packet delay andor packet loss reporting, illustrated as a block 12d. At the application layer, the variable rate andor protection application of block 12v of FIG. 1 is able to vary or switch between or among different rate or quality transmission calls. In operation of the application 12v in a transmitting mode, information, such as, for example, voice information, is applied to application 12v over a path 7. Application 12v receives the information, and processes it, as by data compression, by adding error correcting codes, or both. Application 12v may also packetize the data. The message to be transmitted is sent from variable rate andor protection application 12v to network transport protocol layer 12d by way of interface congestion controller 12icc. Interface congestion controller 12icc does not affect the packet to be transmitted. In order to provide for the possibility of backing off to a lower bit rate of the Variable (or switchable) Rate andor Protection application 12v, Interface Congestion Controller 12icc, together with Network Transport Protocol 12d, stores the processed information in a buffer. The size of the buffer is selected in known manner to prevent excessive latency. Terminal 12, and possibly other similar terminals of a set 11 of terminals, communicate(s) with a gateway or edge router 14.

When variable rate andor protection application 12v of FIG. 1 generates a call or packet, Network Transport Protocol 12d packetizes the information, adds information identifying the terminal making the transmission, and sends the calls to the associated edge router 14. A responsibility of the edge router 14 is to mark every packet received from a terminal, such as terminal 12, of set 11 of terminals. The marking of a packet includes assignment of a particular priority code to the packet. Packet priority marking depends on the user that sent the packet and the rate at which the user is transmitting. If a node has high nominal priority, but its associated terminal is misbehaving by sending at a rate that exceeds the limit specified by the network administrator, the packet will be marked by edge router 14 with a lower actual priority. It should be noted that marking a packet does not mean dropping a packet.

It should be noted that the network 16 of FIG. 1 may be viewed as including its nodes 12 and 20, so the term “network” must be understood in proper context, and could be understood to refer to either element 10 or element 16 of FIG. 1. The transport of information through network 16 of FIG. 1 is performed using a protocol that specifies and controls network traffic by class so that certain types of traffic are given precedence over other types. For example, the flow of voice traffic, which requires relatively uninterrupted flow of data, might be given precedence over text data. The protocol used in network 16 of FIG. 1 might be DiffServ, for example. Marking a packet to a lower priority than its nominal priority, as might occur in edge router 14, means that the packet will have a higher probability of being dropped if the network is, or becomes, congested. The packets received from terminal 12, and from other terminals of set 11 of terminals, and marked by edge router 14, are transmitted onto network 16. Either the edge router 14 or the network 16 includes at least one core router illustrated as a block 16₁.

As packets leave edge router 14 (or enter or leave the network 16), they are differentiated in core router 16, based upon the marked priority code. Those packets having high priority are routed to a queue (not illustrated) having a relatively high rate of transmission or forwarding service, while packets with lower marked priority are routed to other queues (also not illustrated) which are not so frequently serviced. Consequently, high priority packets are serviced or transmitted from the core router more quickly than lower-priority packets. This type of prioritizing results in the dropping or cancellation of lower-priority packets in case of congestion. This dropping occurs when the lower-priority packet queue becomes full, but low-priority packets continue to arrive at the core router. Eventually, all those packets, both high and low priority, which are not dropped make their way through the network 16. The latency or delay of the packets in the network 16 depends, in part, on the assigned priority of the packets. The packets exiting the network 16 arrive at a further gateway or edge router 18, which strips off or removes the packet priority markings. The stripped packets are then routed to the appropriate terminal of a set 19 of terminals, such as terminal 20. Terminals of set 19 are similar to terminals of set 11. More specifically, terminal 20 is similar to terminal 12, in that it includes a variable rate andor protection application 20v at the application level, and also includes supporting interface congestion control layer 20icc. Interface congestion control layer 20icc is, in turn, supported by a network transport protocol with delay and loss reporting, designated 20d. The stripped packets from edge router 18 are supplied by network transport and protocol block 20d to the interface congestion control controller 20icc, together with the packet delay information, the packet dropping information, or both. Packet delay information can be readily derived from packet transmission time markings of the packet, and packet dropping information can be derived or estimated from packet serial numbering information accompanying the arriving packets. Interface congestion control controller 20icc processes the network congestion information from network transport and protocol block 20d to produce one or more rate control signals. Variable rate andor protection application 20v accepts the arriving packets or calls and the rate control signals. The arriving packet is processed and made available as a message on an input-output path 8.

When the system 10 OF FIG. 1 has been in operation for a period of time, the network will carry some traffic loading. So long as the traffic loading is light, congestion control is not required, and messages may be sent at the maximum rate of which the various terminals and routers are capable. Sooner or later, however, the network loading will rise to such an extent that congestion occurs. This congestion is manifested as increasing packet delay, the dropping of packets, or both, and possibly by other factors, such as increasing bit error rate. The congestion information is gathered by the network transport protocol 20d with its delay and loss reporting function. The congestion information is continuously available at network transport protocol 20d for all information arriving at terminal 20.

The network congestion information of packets arriving at terminal 20 of FIG. 1 is evaluated by network transport protocol block 20d. Network transport protocol block 20d generates feedback or acknowledgement packets at a rate which may be roughly once per round-trip time. The feedback packets include congestion information. The congestion information may include the forward or one-way propagation delay, bit error rate, andor the like. The feedback information may also include the packet loss event rate experienced by the receiver, as estimated, for example, from an evaluation of serially numbered packets. The network transport protocol 20.d congestion information feedback packet is coupled to its variable-rate andor protection application 20v to transmit the feedback packet to edge router 18. Network transport protocol 20d commands its variable-rate andor protection application 20v to send the feedback packet at the highest possible rate. Edge router 18 marks the feedback information with the highest priority, and transmits it to the core routers, such as core router 16, of network 16. The core routers process the feedback information at the highest priority, without dropping any of the feedback packets. Eventually, the feedback packets arrive at edge router 14, where the priority information is removed. The feedback packet(s) are evaluated by network transport protocol 12d, and a Variable rate andor protection application transmission rate is selected in interface congestion controller block 12icc based upon the reported congestion. Variable rate andor protection application block 12v adjusts the transmission rate for the next information packet which it receives from path 7 and transmits. The transmission rate adjustment may include increasing the bit transmission rate in the presence of lesser congestion (so long as the maximum possible bit transmission rate has not been reached) and decreasing the bit transmission rate in the presence of congestion. A lower limit of bit transmission rate may be imposed to prevent the system from “turning itself off.”

Since the terminals of sets 12 and 20 of FIG. 1 are identical, at least as to the described characteristics, the same mode of operation occurs for data transmission in the “reverse” direction (taken as being from terminal 20 to terminal 12). In short, information arriving at variable- or switchable-rate andor protection application 20v by way of path 8 is processed, as by data compression, by adding error correcting codes, or both. Other processing may also be performed, such as packetizing. The processed information packets are transmitted at a rate which is established by interface congestion control block 20icc based on previously received feedback packets expressing the congestion encountered in previous transmissions of data from terminal 20 to terminal 12. The transmitted information packets are processed by network transport protocol block 20d and applied, together with other packets from other terminals of set 19 of terminals, to edge router 18, which appends or marks the packets with priority information derived from the identity of source terminal 20. The marked information packets are sent by edge router 18 to one or more core routers, such as core router 16, of FIG. 1. The core routers process the packetized information according to its priority, and in the case of congestion, information packets may be delayed or lost. Those information packets which exit from network 16 are coupled to edge router 14, which strips off the priority markings. The information packets arrive at network transport protocol block 12d of terminal 12. The congestion information is extracted from the information packet arrival information, and feedback packets are generated containing congestion information. The information packets are coupled by way of interface congestion control block 12icc to variable rate andor protection application 12v, and are processed to extract the information and to couple it to a user by way of input-output path 7. The congestion information andor packets are also sent to interface congestion control block 12icc to determine the appropriate transmission rate for the next information packet transmission by variable rate andor protection application block 12v. The congestion packets are also coupled to variable rate andor protection application block 12v in order to be transmitted through the network to terminal 20. The congestion packets are transmitted by variable rate andor protection application block 12v at the maximum rate. The congestion packets are coupled to edge router 14, and are accorded the highest priority, so that congestion information can be most quickly communicated throughout the system. The congestion packets can be identified as such in order to facilitate their identification by the edge router. The congestion packets wend their way back to terminal 20, where their data is extracted and processed by interface congestion controller 20icc for allowing interface congestion controller block 20icc to select the appropriate transmission rate to be used by variable rate andor protection application block 20v for its next transmission of information packets.

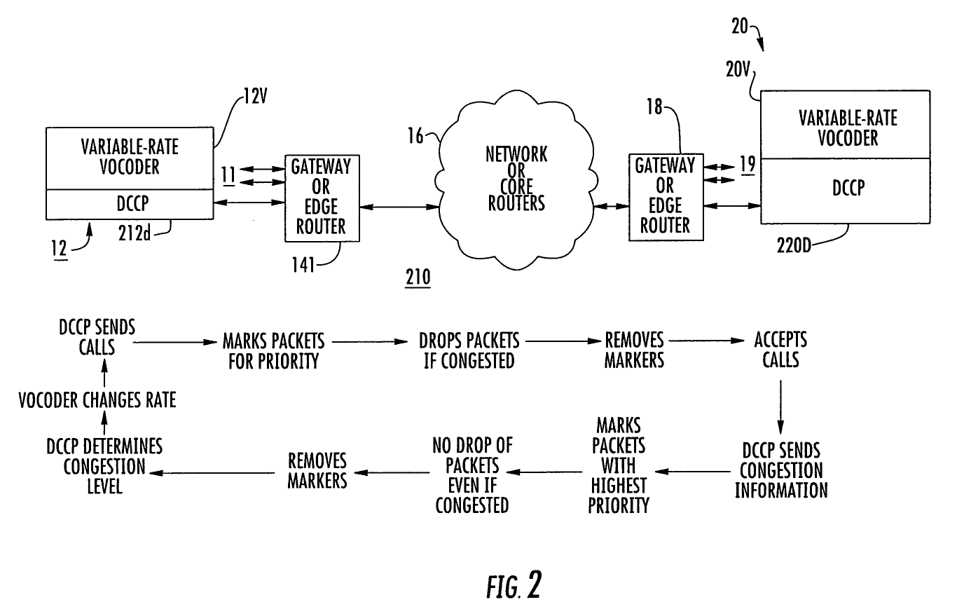

The arrangement of FIG. 2 is similar to that of FIG. 1, with the difference being that the interface congestion control block 12icc and network transport protocol 12d of terminal 12 of FIG. 1 are replaced by a single Datagram Congestion Control Protocol (DCCP) block 212d, and interface congestion control block 20icc and network transport protocol 20d of FIG. 1 are replaced by a single Datagram Congestion Control Protocol (DCCP) block 220d. DCCP is a minimal, general-purpose transport-layer protocol. Its three main functionalities are (1) to provide non-guaranteed packet flow, (2) Establishments Maintenance and Teardown, and (3) Congestion control of the flow. DCCP has two types of congestion control, namely (a) TCP-Like (TCPL), such as CCID2, and (b) TCP-Friendly (TFRC), such as CCID3. The operation of the arrangement of FIG. 2 is generally similar to that of the arrangement of FIG. 1. More particularly, the signaling decision for switching variable rate andor protection application 12v comes from DCCP 220d of FIG. 1, which evaluates the congestion level in the network and decides which transmission rate is most appropriate. DCCP 220d generates feedback or acknowledgement packets at a rate which may be roughly once per round-trip time. The feedback packets include congestion information. The congestion information may include the forward or one-way propagation delay, bit error rate, andor the like. The feedback information may also include the packet loss event rate experienced by the receiver. The DCCP 220d congestion information feedback packet is coupled to its variable-rate andor protection application 20v to transmit the feedback packet to edge router 18. DCCP 220d commands its variable-rate andor protection application 20v to send the feedback packet at the highest possible rate. Edge router 18 marks the feedback information with the highest priority, and transmits it to the core routers of the network 16. The core routers process the feedback information at the highest priority, without dropping any of the feedback packets. Eventually, the feedback packets arrive at edge router 14, where the priority information is removed. The feedback packet(s) are evaluated by DCCP 212d, and a variable rate andor protection application transmission rate is selected based upon the reported congestion. Variable rate andor protection application 12v adjusts the transmission rate for the next information packet which it transmits, increasing the bit transmission rate in the presence of lesser congestion (so long as the maximum possible bit transmission rate has not been reached) and decreasing the bit transmission rate in the presence of congestion. As described in conjunction with FIG. 1, a lower limit of bit transmission rate may be imposed to prevent the system of FIG. 2 from “turning itself off.”

In one simulated possible embodiment according to an aspect of the invention, the variable rate andor protection applications, such as 12 and 20 of FIG. 1 or 2, are operated at one of three possible levels, which are high quality of 1666.6 bytes/second, medium quality of 833 Bytes/second, and off, which means no transmission. The variable rate andor protection application is operated by being ON for about 1.2 seconds and OFF for 1.4 seconds, with the ON/OFF decision based on an exponential distribution. The average on-time is then 1.2/(1.2+1.4)=0.46. The packets had a 50-byte payload. The abovementioned simulations used TFRC as the congestion control algorithm of DCCP because smooth ramp-up and ramp-down of the packet flow are desirable. TCPL was not used, because RCPL uses linear increase and multiplicative decrease, which would not work well in a real time voice environment.

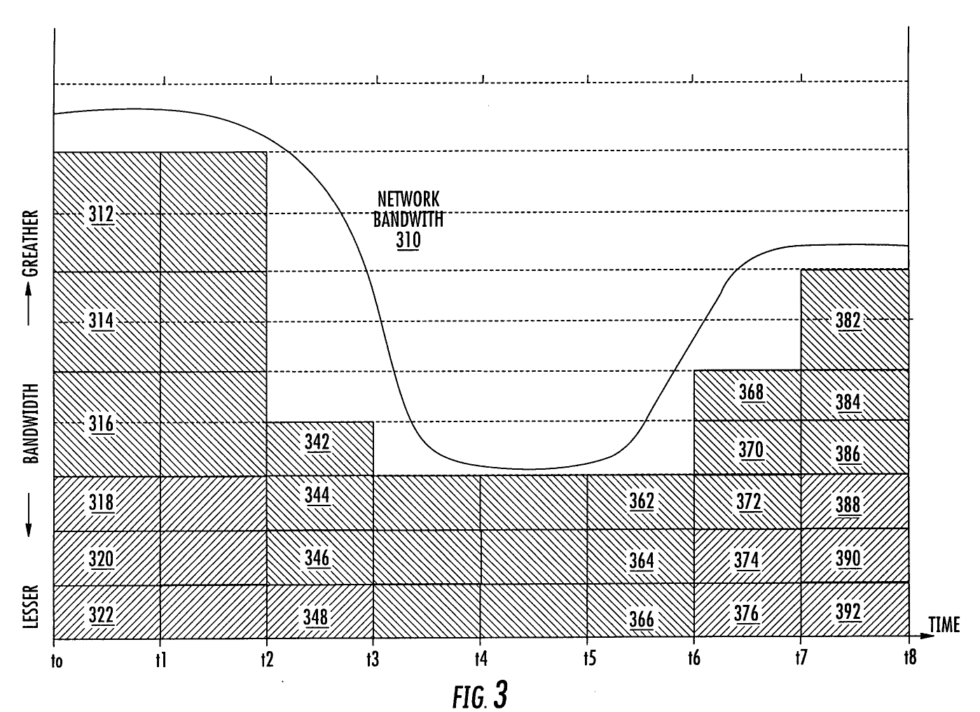

FIG. 3 illustrates a plot 310 of instantaneous network available bandwidth versus time, where the available bandwidth changes, possibly caused by system loading or by physical factors such as path fade. At the left of FIG. 3, the bandwidth represented by plot 310 is greatest, and the throughput in intervals t0 to t1 and t1 to t2 is illustrated as including a total of six calls served by the network, three of which have high priority, and three of which have low priority. This allowed throughput arises from the operation of the system of FIG. 1 or FIG. 2. The high priority calls are illustrated by hatching which slants from upper left to lower right, and the low priority calls are illustrated by hatching which slants from lower left to upper right. Thus, in the high-bandwidth intervals t0 to t1 and t1 to t2, high priority calls being served are designated 312, 314, and 316. During the same interval t0 to t1 and t1 to t2, the low-priority calls being served are designated 318, 320, and 322. It will be apparent from FIG. 3 that the high-priority calls 312, 314, and 316 are afforded about twice the bandwidth as the low-priority calls 318, 320, and 322, as evidenced by their greater dimension in the vertical (bandwidth) dimension. In the interval t1 to t2, the network bandwidth is about the same as in time interval t0 to t1, and so the same service is allowed, namely three high-priority, “full” bandwidth packets, and three low-priority, “half” bandwidth packets. At a later time than t2, the system bandwidth is reduced. In the interval t2 to t3, the available network bandwidth is such that the three current high-priority calls, designated 342, 344, and 346, are not dropped, but have their bandwidth curtailed or reduced to “half” bandwidth. There is sufficient additional bandwidth in the interval t2 to t3 to allow service at “half” bandwidth of one additional low-priority call, which is illustrated as 348. In the intervals t3-t4, t4-t5, and t5-t6 the network bandwidth reaches a minimum value, as indicated by the level of plot 310. In those three intervals, the bandwidth is sufficient to carry only three high-priority calls at “half-bandwidth”. The three high-priority calls carried in the interval t5-t6 are designated 362, 364, and 366. In the interval t6-t7 of FIG. 3, the network bandwidth 310 increases above the minimum which occurred during interval t3-t6, so that in the interval t6-t7 three high-priority calls, namely calls 368, 370, and 372 are serviced at “half” bandwidth, together with two low-priority calls, namely 374 and 376. Finally, in the time interval t7-t8 of FIG. 3, the bandwidth 310 increases almost to the same level as that which existed during the intervals t0-t4. In the interval t7-t8, the network services a full-bandwidth high-priority call 382, two “half-bandwidth” high-priority calls 384 and 386, and three low-priority calls 388, 390, and 392.

It may be desirable to modify the congestion control aspect or algorithm of DCCP to fit the specific application. For example, it may be desirable to modify the algorithm for applications such as Voice over Internet Protocol (VoIP). Delay occurs in DCCP when the TCP-Friendly Rate Control buffers packets flowing in the forward direction when there is congestion. DCCP strengths are with non-real time applications in which delay is not much of an issue. Therefore, the Variable rate andor protection application is very helpful because instead of backing off and buffering packets, DCCP can back off and change to a lower rate Variable rate andor protection application. A modification of the congestion control aspect of DCCP bases the congestion determination on round trip time. Long Round Trip Time (RTT) comes from lost packets, and time spent waiting in a queue. This directly translates into congestion in the network. When queues are building up, then round trip time will become longer. When there are drop packets then queues will be even longer. Round trip time takes into account the time duration between the time that an information packet is sent and the time at which an acknowledgement returns. If a packet sent is dropped in the core, then resending a packet will not reset the time. For example, if a packet was sent, the time it was sent is saved in the header. If the packet is lost in the core, then after a timeout event, the same packet is retransmitted, with an indication of the time at which the first packet was out. When the destination node receives the packet, it will strip the time from the header and put it in the ACK packet. When the ACK packet arrives to the original sender, the original sender will subtract the current time from the time in the header.

DCCP is better than TCP for voice applications. TCP is not advantageous for voice calls because of TCP's characteristics of retransmission and burstiness. Whenever TCP encounters a loss packet or packet error, it would automatically retransmit the packet. In voice calls, this could mean a huge delay for at least some packets. In general, voice calls prefer that a packet be dropped instead of retransmitted. TCP has bursty traffic because of the slow start and the linear increase and multiplicative decrease algorithm. Voice calls prefer a constant rate.

DCCP is better than UDP for voice applications, because UDP has no feedback mechanisms. When a network is congested, UDP is not aware of the other nodes, and will keep on transmitting packets at a high rate. This will, in turn, tend to congest the whole network, possibly allowing no calls to go through.

The use of DCCP in a DiffServ-based network takes the best from both worlds. From TCP it takes the reliable connection setup or the 3-way handshake so it can establish the right congestion control protocol. Also, DCCP takes the congestion detection from TCP. Congestion detection comes from the ACKnowledgements (ACKs) that are received. The ACKs provide information such as loss event rate and roundtrip time. Further, comparing DCCP's overhead to that of UDP and TCP, DCCP has 12 Bytes of header information, while UDP has 8 Bytes and TCP has 40 Bytes. DCCP, like UDP, never retransmits. The ACK packets that come back only provide information of the congestion level. Similar to TCP, DCCP has a connection initiation and a connection teardown. In both the connection initiation and teardown, DCCP performs a 3-way handshake. The data transfer section is similar to UDP where data is sent but there are no retransmissions. ACK packets are sent back so the network congestion level can be evaluated.

In a particular mode of the method, the step of gathering operational information includes evaluation of packet delay based on the difference of arrival and transmit times. Additionally, the delay can be estimated based on the difference of queue depth on arrival and departure. Packet loss can be estimated by the order of sequence numbers. Additionally, packet loss can be estimated by the non arrival of an acknowledgement in a certain period of time. For bi-directional applications, loss can be estimated by examining the incoming stream of data by the other communicating node.

In another mode of the method, the step of transmitting arrival confirmation information back to the originating node includes the step of incorporating arriving packet bit error rate information into the arrival confirmation information. In this mode, the step of adjusting the bit rate of a subsequent packet transmission is further responsive to the bit error rate.

In yet another mode of the method, if a packet loss or error rate is less than a certain policy-driven threshold, an application may be allowed to increase to improve application fidelity so long no indication of unacceptable congestion or loss is received.

A method according to an aspect of the invention is for communicating among multiple nodes (12,20) of a network (10,16). The network (10,16) has limited bandwidth, and comprises at least plural nodes (12,20). The method comprises the step of providing a plurality of applications (12V,20V) at least one of the nodes (12,20), where each of the applications (12V,20V) has at least one of (a) transmission rate and (b) protection or error rate which differs from others of the applications (12V,20V) at the corresponding node. The method provides network (10,16) transport (12d,20d) with a network (10,16) transport protocol (DCCP, for example) that reports network (10,16) performance characteristics. These characteristics may be indications of network (10,16) congestion, such as delay or packet nonarrival. The network (10,16) performance characteristics are processed for selecting a particular one of the applications (12V,20V) in such a manner to tend to maintain the QoS.

According to another aspect of the invention, a method for communication among multiple nodes (12,20) of a bandwidth-limited network (10,16) which comprises at least first and second nodes (12,20) comprises the step of, at each of the first and second nodes (12,20), providing a plurality of applications (12V,20V). Each of the applications (12V,20V) has at least one of (a) transmission rate and (b) protection which differs from others of the applications (12V,20V) at the corresponding node. The application may be viewed as including a plurality of subapplications, each of which has a different transmission rate or protection, or the applications may be viewed as being variable-rate. A network (10,16) transport protocol is provided, which reports network (10,16) performance characteristics such as congestion delay or nonarrival. One of the plurality of applications, or possibly subapplications (12V,20V) is selected in response to the network (10,16) performance characteristics to tend to maintain a given QoS.

A method according to an aspect of the invention is for communicating among multiple users (12, 20, . . . ) by way of a network (16) defining nodes (14, 18) and having a limited bandwidth and operating in a differential service mode responsive to packet or message priority. Each of the nodes (14, 18) is associated with a gateway, and each of the gateways is associated with a set of variable-bit-rate Variable rate andor protection applications (12v, 20v, . . . ), which set may contain as few as one Variable rate andor protection application. The method comprises the step of, at any one of the Variable rate andor protection applications (12v, 20v, . . . ) of a set, transmitting information packets at a bit rate to an associated gateway (14,18) together with information identifying the particular Variable rate andor protection application (12v) from which the packet transmission is made, and possibly noting the time at which the packet was transmitted. At each gateway (14,18), the Variable rate andor protection application (12v, 20v, . . . ) identification information is compared with prestored information relating the Variable rate andor protection application (12v, 20v, . . . ) identification to packet priority, to thereby assign a user priority to each of the information packets. The gateway (14,18) communicates the packet and its user priority over the network. The network may delay the packets, depending upon the priority, and may even drop some packets. When the packet reaches its destination, arrival confirmation information is transmitted back, over the network, to that one Variable rate andor protection application (12v, 20v, . . . ) which originated the packet. The arrival confirmation information includes at least information relating to one of (a) the time of arrival of the packet at its destination, (b) nonarrival of the packet and (c) bit error rate of the packet as received. At the one Variable rate andor protection application, (a) if the confirmation information includes the time of arrival of the packet, the time of transmission of the packet is compared with the time of arrival of the packet, (b) if the confirmation information includes nonarrival, the nonarrival information is evaluated, and (c) if the confirmation information includes bit error rate information, the bit error rate is evaluated, all to produce network congestion information, and the bit rate of a subsequent packet transmission is adjusted in response thereto. Ordinarily, when congestion is present, the Variable rate andor protection application bit rate on subsequent packet transmissions is reduced. A minimum bit rate may be applied.

In a particular mode of the method, the step of transmitting arrival confirmation information includes the step of transmitting in a DDCP protocol, and in some modes, one of TCP and UDP protocols.

In yet another mode of the method, the step of transmitting information packets at a bit rate to an associated gateway includes the step of transmitting the information packets at the highest possible bit rate so long no indication of congestion is received.

In another mode of the method, the step of transmitting arrival confirmation information back to the originating Variable rate andor protection application includes the step of incorporating into the arrival confirmation information matter or information relating to the bit error rate of the arrived packet. In this mode, the step of adjusting the bit rate of a subsequent packet transmission is further responsive to the bit error rate.

What is claimed is:

1. A method for communicating among multiple nodes of a network, said network having limited bandwidth and comprising at least plural nodes, said method comprising the steps of:
providing a plurality of applications at least one of said nodes, each of said applications having at least one of (a) transmission rate and (b) protection [error] which differs from others of said applications at the corresponding node;
providing network transport with a network transport protocol that reports network performance characteristics; and
processing said network performance characteristics for selecting a particular one of said applications in such a manner to tend to maintain the QoS.

2. A method according to claim 1, wherein said network transport protocol reports network performance characteristics from which round-trip time can be derived; and
said step of processing said network performance characteristics includes the step of determining round-trip time.

3. A method according to claim 2, wherein said step of determining round-trip time includes the step of determining round-trip time measured from the initial transmission of an information packet until the time of arrival of an acknowledgement packet for one of (a) the initial transmission and (b) a subsequent transmission of the same information packet.

4. A method for communication among multiple nodes of a network having limited bandwidth and comprising at least first and second nodes, said method comprising the steps of:
at each of said first and second nodes, providing a plurality of applications, each of said applications having at least one of (a) transmission rate and (b) protection which differs from others of said applications at the corresponding node;
providing a network transport protocol which reports network performance characteristics; and
selecting among said plurality of applications in response to said network performance characteristics to tend to maintain a given QoS.

5. A method according to claim 4, wherein said network transport protocol reports network performance characteristics from which round-trip time can be derived; and
said step of selecting among said plurality of applications in response to said network performance characteristics includes the step of determining round-trip time.

6. A method according to claim 5, wherein said step of determining round-trip time includes the step of determining round-trip time measured from the initial transmission of an information packet until the time of arrival of an acknowledgement packet for one of (a) the initial transmission and (b) a subsequent transmission of the same information packet.

7. A method for communicating among multiple users by way of a network defining nodes, having a limited bandwidth, and operating in a differential service mode, each of said nodes being associated with a gateway, and each of said gateways being associated with a set including at least one Variable rate andor protection application, said method comprising the steps of:
at any one of the Variable rate andor protection applications of a set, transmitting information packets at a bit rate to an associated gateway together with information identifying the particular Variable rate andor protection application from which the packet transmission is made;
at each gateway, comparing the Variable rate andor protection application identification information with prestored information assigning priority based on Variable rate andor protection application identification, to thereby assign a user priority to each of said information packets, and communicating said packet and user priority information over said network;
when said packet reaches its destination, transmitting arrival confirmation information back over said network to that one Variable rate andor protection application which originated the packet, said arrival information including at least one of (a) information relating to time of arrival of said packet, (b) information relating to nonarrival of a packet, and (c) bit error rate of said packet;
at said one Variable rate andor protection application, (a) if said confirmation information includes time of arrival of said packet, comparing the time of transmission of said packet with the time of arrival of said packet, if said confirmation information includes packet nonarrival information evaluating said nonarrival information, and (c) if said confirmation information includes bit error rate, evaluating said bit error rate, to generate congestion information, and adjusting the bit rate of a subsequent packet transmission in response thereto.

8. A method according to claim 7, wherein said method further includes the step at said Variable rate andor protection application of noting the time at which the packet was transmitted.

9. A method for communicating among multiple users by way of a network defining nodes and having a limited bandwidth, each of said nodes being associated with a gateway, and each of said gateways being associated with a set including at least one variable-bit-rate Variable rate andor protection application, said method comprising the steps of:
at any one of the Variable rate andor protection applications of a set, transmitting information packets at a bit rate to an associated gateway together with information identifying the particular Variable rate andor protection application from which the packet transmission is made, and noting the time at which the packet was transmitted;
at each gateway, comparing the Variable rate andor protection application identification information with prestored information assigning priority based on Variable rate andor protection application identification, to thereby assign a user priority to each of said information packets, and communicating said packet and user priority over said network;
when said packet reaches its destination, transmitting arrival confirmation information back to that one Variable rate andor protection application which originated the packet, said arrival information including at least information relating to time of arrival of said packet;
at said one Variable rate andor protection application, comparing the time of transmission of said packet with one of (a) the time of arrival of said packet and (b) a lack of said arrival confirmation within a predetermined time, and adjusting the bit rate of a subsequent packet transmission in response thereto.

10. A method according to claim 9, wherein said step of transmitting arrival confirmation information includes the step of transmitting in a DDCP protocol.

11. A method according to claim 9, wherein said DDCP protocol is one of TCP and UDP.

12. A method according to claim 9, wherein said step of transmitting arrival confirmation information back includes the step of incorporating into said arrival confirmation information relating to the bit error rate of the arrived packet; and
said step of adjusting the bit rate of a subsequent packet transmission is further responsive to said bit error rate.

13. A method according to claim 9, wherein said step of transmitting information packets at a bit rate to an associated gateway includes the step of transmitting said information packets at the highest possible bit rate so long no indication of congestion is received.
